(19) United States
(12) Patent Application Publication
(10) Pub. No.: US 2021/0014458 A1
(43) Pub. Date: Jan. 14, 2021

(54) ENTITY ANALYSIS AND TRACKING IN A SURVEILLANCE SYSTEM

(71) Applicant: Honeywell International Inc., Morris Plains, NJ (US)

(72) Inventors: Dinesh Babu Rajamanickam, Thanjavur (IN); Sunil Madusudanan, Nagercoil (IN)

(73) Assignee: Honeywell International Inc., Morris Plains, NJ (US)

(21) Appl. No.: 16/505,017

(22) Filed: Jul. 8, 2019

(51) Int. Cl. H04N 7/18; H04N 5/44

(52) U.S. Cl. CPC H04N 7/181; H04N 5/4403

(57) ABSTRACT

A surveillance system having one or more cameras, each configured with a field-of-view (FOV) in a map displayed on a screen of a panel viewer. An entity may be tagged within an FOV of a current camera of the one or more cameras by clicking or drawing with a cursor on a screen showing the entity within the FOV, which results in a closed geometrical line around at least a portion of the entity displayed within the FOV. When the entity moves, the geometrical outline may move with the entity from an FOV of one camera to an FOV of another camera. One or more adjacent cameras having FOV's that are close to, adjacent to or overlapping to the FOV of the current camera, may be loaded with the map on the screen of the panel viewer.

### BACKGROUND

The present disclosure pertains to detection and analyses of entities.

### SUMMARY

The disclosure reveals a surveillance system having one or more cameras, each configured with a field-of-view (FOV) in a map displayed on a screen of a panel viewer. An entity may be tagged within an FOV of a current camera of the one or more cameras by clicking or drawing with a cursor on a screen showing the entity within the FOV, which results in a closed geometrical line around at least a portion of the entity displayed within the FOV. When the entity moves, the geometrical outline may move with the entity from an FOV of one camera to an FOV of another camera. One or more adjacent cameras having FOV's that are close to, adjacent to or overlapping to the FOV of the current camera, may be loaded with the map on the screen of the panel viewer.

### BRIEF DESCRIPTION OF THE DRAWING

FIG. 1 is a diagram of a flow chart of an approach for an entity analysis and tracking in a surveillance system; and

FIG. 2 is a diagram visualizing in a layout of components for the present system of FIG. 1.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

Aspects of the system or approach may be described in terms of symbols in the drawing. Symbols may have virtually any shape (e.g., a block) and may designate hardware, objects, components, activities, states, steps, procedures, and other items.

Some issues related to analysis and tracking may be described in the following. Movement information of either a single person or a baggage in a facility across the multiple camera views may be difficult to identify even with the help of a related art closed circuit television (CCTV) system. Incident management and inference in video surveillance systems appear extremely complex and time consuming. One may need to analyze the video playback of all the other nearby cameras for that particular time frame. But this activity may consume much time and moreover one might not be able to get the entire sequence of the event. In case of future event predictions, it is not necessarily possible to predict any actions or an event sequence which may happen with related art surveillance systems.

With some systems, to track a person automatically and load adjacent cameras for the viewer with multiple cameras for any incident analysis could be difficult. In order to achieve this, a user should pre-define and configure the surrounding cameras to load the adjacent cameras into a panel viewer based on the person or baggage moment across cameras manually. This may be a long customer pain point and no one seems to have an easy way to do this.

With the present system, a video monitoring application may identify and track a person from multiple cameras using a built-in analytics engine. Steps may incorporate the following items: 1) Load a map inside a video monitoring application; 2) Configure all the cameras available in the premises into the floor map of any format; 3) Set a field-of view (FOV) coverage as per camera position in the map for all the added cameras. 4) If there are walls or objects which block the camera view, one may specify the same in the map as object blockers; 5) Now the analytics engine may learn the camera positions, FOV's of the cameras, distances between cameras, floor structures like number and design of floors, walls, entries and exits, and so forth, from the map; 6) Tag the object or person to be tracked; 7) An analytics engine running inside video monitoring application may identify the cameras adjacent to one another with the help of the map; 8) Now if any tagged object or person moves from one camera FOV to another camera FOV, then that means the analytics engine running inside the video monitoring application may find a current camera and load adjacent nearby cameras to the viewer; 9) In addition to that, one may draw the object or person moment along with video loading in the map also; 10) One may display the time taken from one camera to another camera in a pictorial form in the map; 11) When one clicks on a route map of a display, the present system may playback the video in the map view or associated video management for client ease of use.

An analytics engine may identify the tagged person moment from one camera to another camera based on the following parameters: 1) a camera FOV; 2) camera co-ordinates; 3) a moving direction of an object or person in six dimensions (i.e., north, east, west and south, upwards and downwards); 4) an object color; and 5) an object size. There may be additional or different parameters.

The system may be extended as indicated by the following items. Multiple maps may be linked. If person or object can walk or move, respectively, across a location, the person or object also can be tracked using linked maps. In other words, the person or object can be tracked from one map to another map. The system may be applicable for an integrated security system and/or a building management system (BMS), any type of floor maps like AutoCAD, building information modeling, 3D modeling, and so forth. There may be a calculating distance between the camera points, and adding notes on the generated maps. An option may be to save the route map as a file. There also may be an option to export a route map with an event for a specified amount of time, e.g., time spent between defined entry and exit points, any number of entries and exits, counts, and other data or information.

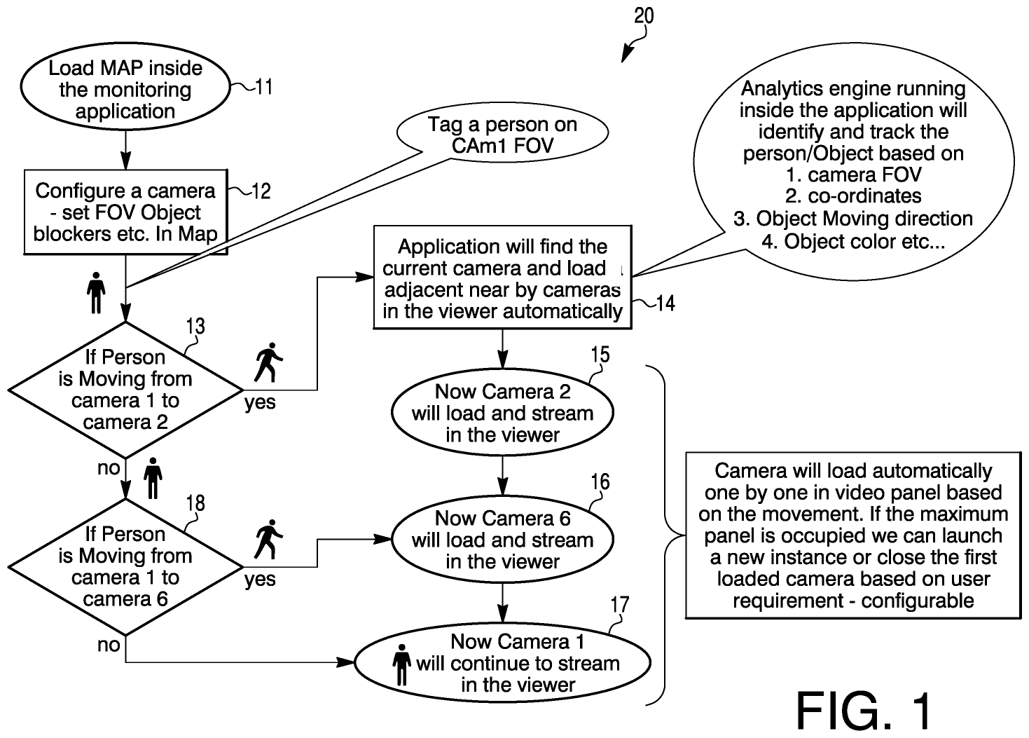

FIG. 1 is a diagram of a flow chart 20 of the present approach for a suspect, person, object, target, or the like (hereafter “entity”) analysis and tracking in a surveillance system. At symbol 11, a map may be loaded inside a monitoring application (app). A camera may be configured at symbol 12 with a setting of an FOV, object blockers, and so on, in a map. The entity may be tagged on a camera 1 FOV at an input to symbol 13.

A question at symbol 13 may be whether the entity is moving from camera 1 to a camera 2. If the answer is “yes”, then at symbol 14 the application may find the current camera and load adjacent nearby cameras in the viewer automatically. An analytics engine running inside the application may identify and track the entity based on: 1) a camera FOV; 2) coordinates; 3) a moving direction of the entity; 4) an entity color; 5) an entity size; and so on.

At symbol 15, camera 2 may now load and stream into the viewer. At symbol 16, for example, a camera 6, may now load and stream into the viewer. Then at symbol 17, camera 1 may continue to stream into the viewer.

At symbols 15, 16 and 17, a camera may load automatically one by one into a video panel based on the movement of the entity. If the maximum panel is occupied, one may launch a new instance or close the first loaded camera based on a user requirement or configuration.

If the answer to the question of whether the entity is moving from camera 1 to camera 2 is “no”, then at symbol 18 there is a question of whether the entity is moving from camera 1 to, for instance, camera 6. If the answer is “yes”, then at symbol 16, camera 6 may now load and stream into the viewer. If the answer is “no”, then camera 1 may now continue to stream into the viewer.

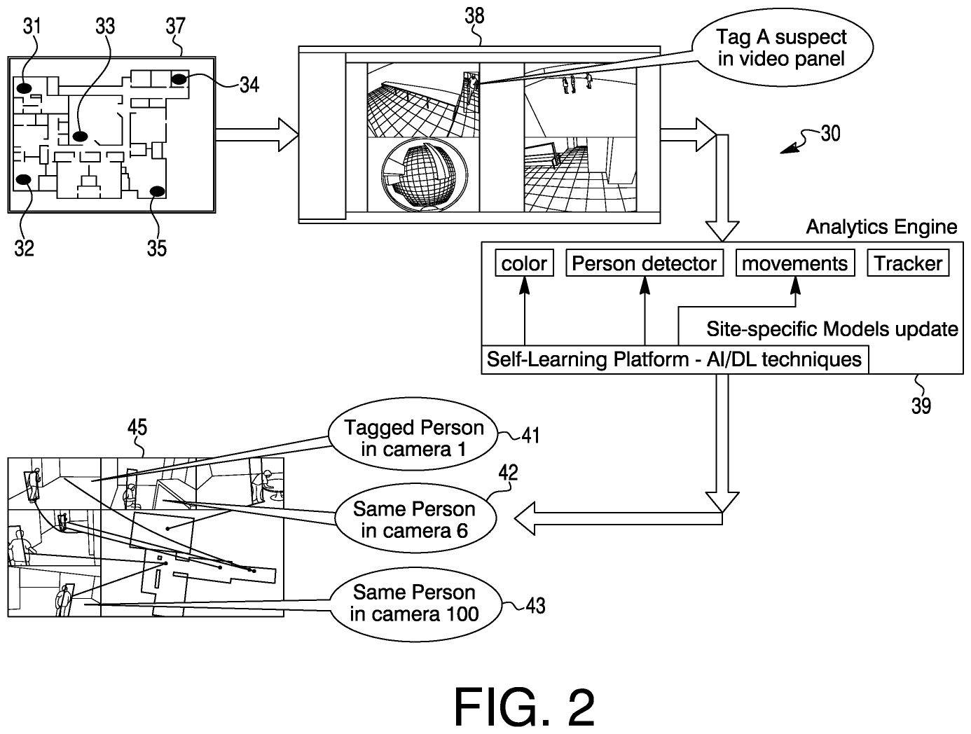

FIG. 2 is a diagram visualizing in a layout 30 of the present system. A floor plan 37 may be a map having position and FOV for each of cameras 31, 32, 33, 34 and 35 located on floor plan 37. Video from one or more cameras 31-35 may go to a video panel or panel viewer 38. An entity may be tagged there to enable tracking of the entity. Tagging may be a rectangle or other geometrical figure around at least a portion of the entity. The rectangle may stick with the entity when the entity moves about. Video of a tagged entity may go from panel 38 to an analytics engine 39 for an analysis made of entity features such as colors, entity detection, movements, tracker function, size, new information, and so on. Analytics engine 39 may operate to identify a flow of the tagged entity. Engine 39 may have a self-learning platform, with artificial intelligence/deep learning (AI/DL) techniques, which has ability to learn camera position, distances between cameras, FOV's of cameras, floor views, entry and exit points and an ability to identify in real time a possible next set of cameras for each camera in the map, and may provide inputs for color, entity detection, movements, a tracker and so forth. Engine 39 may provide a site-specific model update.

Analytic engine 39 may be on a premise or on a cloud. There may be a pre-request for analytic engine 39. A map may be configured with a camera location, FOV, object blocker, and so forth. Analytic engine 39 (as an algorithm) may involve an operator marking a person whom that needs to be tracked. Analytic engine 39 may know now whom to track, where the person and current cameras nearby using the map. Analytic engine 39 may identify the person's movement based on object size, color, co-ordinate and direction. Based on movement, analytic engine may identify the next nearby camera by using the pre-configured map. Now, analytic engine 39 may load the identified next nearby cameras into a viewer application to track the person.

An output of analytics engine 39 may go to a multiple picture display 45 with images from some of cameras 31-35, plus numerous other cameras not previously mentioned in this description. For examples, screen portion 41 shows the tagged entity in camera 1, portion 42 shows the entity in camera 6, and portion 43 shows the entity in camera 100. The entity may be shown in screen portions from other cameras. Display 45 may provide a representation of an actual output of a tagged entity.

The present system and its app may incorporate a software component that has a stack level for consumption. It may have domain specific, differentiated software enabled offerings and services delivered via a cloud or private enterprise network. The software type may be a packaged software product, that is, software provided to the customer for installation on a PC/system for use (e.g., Microsoft Word™).

A Windows™ or Linus™ operating system hardware, for example, may be used to implement the present system. Associated software may incorporate Maxpro VMS™, Maxpro NVR™, ProWatch™, Xtralis™, and/or the like.

To recap, a surveillance system may incorporate one or more cameras, each configured with a field-of-view (FOV) in a map displayed on a screen of a panel viewer. An entity may be tagged within an FOV of a current camera of the one or more cameras by clicking, or drawing with a cursor, on a screen showing the entity within the FOV, which results in a geometrical line around at least a portion of the entity displayed within the FOV. When the entity moves, the geometrical line may move with the entity from an FOV of one camera to an FOV of another camera until a current camera is selected at which to stay for observing the entity as long as the entity is within the FOV of the current camera.

One or more adjacent cameras having FOV's that are close to, adjacent to or overlapping to the FOV of the current camera, may be loaded with the map on the screen of the panel viewer.

The entity may be classified and identified according to one or more parameters selected from a group including an FOV of a camera, coordinates of the camera relative to a predetermined coordinate system, a direction of movement of the entity relative to the coordinate system, a color or colors of the entity, and a size of the entity.

Another camera may load and stream into the panel viewer, and the current camera may continue to stream into the panel viewer.

Cameras may load automatically one by one in the video panel viewer based on movement of the entity, or if a maximum capacity of the video panel viewer is occupied, a new instance camera or the first loaded camera may be closed.

If the entity does not move from the current camera to another camera, then a question of whether the entity can move from the current camera to a camera other than the other camera, arises, and if so, then the camera other than the other camera may load and stream into the video panel viewer, but if not, then the current camera may continue to stream into the panel video viewer. The entity may be one or more items of a group comprising a suspect, person, object and target.

A surveillance approach may incorporate loading a map inside a video monitoring application (app), configuring cameras at a set of premises as indicated by the map, setting FOV coverage with a position of each camera on the map, specifying items that at least partially obstruct FOV coverage by a camera, as object blockers, learning a camera position on the map with an analytics engine, tagging an entity to be tracked, identifying cameras adjacent to one another from the map with the analytics engine, and finding a current camera that loads adjacent cameras to a viewer. Movement of a tagged entity from one camera FOV to another camera FOV may be detected by the analytics engine.

The approach may further incorporate drawing an entity moment of inertia, area or perimeter along with video loading of the entity moment into the map.

The approach may further incorporate clicking on a route of the map on a screen to playback video of the route in the map.

A tagged entity moment from one camera to another camera may be identified by the analytics engine according to one or more parameters selected from a group comprising a camera FOV, camera coordinates, direction of movement of the tagged entity moment in one or more six dimensions, entity color and entity size.

Multiple maps may be put together as linked maps. A moving tagged entity moment may be tracked across or among the linked maps.

The approach may further incorporate calculating distances between camera points with the analytics engine, and displaying time taken for switching from one camera to another camera in a pictorial form in the map.

The approach may further incorporate adding notes to the map.

The route map may be saved as a file.

The route map may be exported for a specified time.

A camera arrangement may incorporate a floor plan map, a plurality of cameras located in the floor plan map, and a video panel. One or more cameras of the plurality of cameras may be connected to the video panel. A suspect may be tagged, if seen on one of the cameras, for tracking. A video of the suspect as tagged and tracked on one of the cameras may go to the video panel. The video of the suspect may go from the video panel to an analytics engine for analysis.

Analysis may incorporate detecting colors, movements, and tracking function, and identification of flow of the tagged suspect.

The analytics engine may have a self-learning platform.

The arrangement may be implemented with a Windows' or Linus™ operating system hardware. Software associated with the hardware may include Maxpro VMS™ Maxpro NVR™, ProWatch™, or Xtralis™.

Any publication or patent document noted herein is hereby incorporated by reference to the same extent as if each publication or patent document was specifically and individually indicated to be incorporated by reference.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

1. A surveillance system comprising:
one or more cameras, each configured with a field-of-view (FOV) in a map displayed on a screen of a panel viewer; and
wherein:
an entity is tagged within an FOV of a current camera of the one or more cameras by clicking, or drawing with a cursor, on a screen showing the entity within the FOV, which results in a geometrical line around at least a portion of the entity displayed within the FOV; and
when the entity moves, the geometrical line moves with the entity from an FOV of one camera to an FOV of another camera until a current camera is selected at which to stay for observing the entity as long as the entity is within the FOV of the current camera.

2. The system of claim 1, wherein one or more adjacent cameras having FOV's that are close to, adjacent to or overlapping to the FOV of the current camera, are loaded with the map on the screen of the panel viewer.

3. The system of claim 1, wherein the entity is classified and identified according to one or more parameters selected from a group including an FOV of a camera, coordinates of the camera relative to a predetermined coordinate system, a direction of movement of the entity relative to the coordinate system, a color or colors of the entity, and a size of the entity.

4. The system of claim 1, wherein another camera loads and streams into the panel viewer, and the current camera continues to stream into the panel viewer.

5. The system of claim 4, wherein:
cameras load automatically one by one in the video panel viewer based on movement of the entity; or
if a maximum capacity of the video panel viewer is occupied, a new instance camera or the first loaded camera can be closed.

6. The system of claim 5, wherein if the entity does not move from the current camera to another camera, then a question of whether the entity can move from the current camera to a camera other than the other camera, arises, and if so, then the camera other than the other camera may load and stream into the video panel viewer, but if not, then the current camera continues to stream into the panel video viewer.

7. The system of claim 1, wherein the entity is one or more items of a group comprising a suspect, person, object and target.

8. A surveillance method comprising:
loading a map inside a video monitoring application (app);
configuring cameras at a set of premises as indicated by the map;
setting FOV coverage with a position of each camera on the map;
specifying items that at least partially obstruct FOV coverage by a camera, as object blockers;
learning a camera position on the map with an analytics engine;
tagging an entity to be tracked;
identifying cameras adjacent to one another from the map with the analytics engine; and
finding a current camera that loads adjacent cameras to a viewer; and
wherein movement of a tagged entity from one camera FOV to another camera FOV is detected by the analytics engine.

9. The method of claim 8, further comprising drawing an entity moment of inertia, area or perimeter along with video loading of the entity moment into the map.

10. The method of claim 9, further comprising clicking on a route of the map on a screen to playback video of the route in the map.

11. The method of claim 10, wherein a tagged entity moment from one camera to another camera is identified by the analytics engine according to one or more parameters selected from a group comprising a camera FOV, camera coordinates, direction of movement of the tagged entity moment in one or more six dimensions, entity color and entity size.

12. The method of claim 10, wherein:
multiple maps are put together as linked maps; and
a moving tagged entity moment can be tracked across or among the linked maps.

13. The method of claim 10, further comprising:
calculating distances between camera points with the analytics engine; and
displaying time taken for switching from one camera to another camera in a pictorial form in the map.

14. The method of claim 10, further comprising adding notes to the map.

15. The method of claim 10, wherein the route map is saved as a file.

16. The method of claim 15, wherein the route map is exported for a specified time.

17. A camera arrangement comprising:
a floor plan map;
a plurality of cameras located in the floor plan map; and
a video panel; and
wherein:
one or more cameras of the plurality of cameras are connected to the video panel;
a suspect is tagged, if seen on one of the cameras, for tracking;
a video of the suspect as tagged and tracked on one of the cameras goes to the video panel; and
the video of the suspect goes from the video panel to an analytics engine for analysis.

18. The arrangement of claim 17, wherein analysis comprises detecting colors, movements, and tracking function, and identification of flow of the tagged suspect.

19. The arrangement of claim 18, wherein the analytics engine has a self-learning platform.

20. The arrangement of claim 19, wherein:
the arrangement is implemented with a Windows™ or Linus™ operating system hardware; and
software associated with the hardware includes Maxpro VMS™, Maxpro NVR™ ProWatch™, or Xtralis^{T}
